(19) United States
(12) Patent Application Publication
(10) Pub. No.: US 2006/0032324 A1
(43) Pub. Date: Feb. 16, 2006

(54) Electric vehicle safety control shaft capable of flexible movements

(76) Inventor: Ferretti Chang, Taipei (TW)

Correspondence Address: Chien Ti Enterprise Co., Ltd., P.O. Box no. 6-57, Junghe, Taipei, 235, TW

(21) Appl. No.: 10/915,479

(22) Filed: Aug. 11, 2004

(51) Int. Cl. G05G 1/00

(52) U.S. Cl. 74/469

(57) ABSTRACT

An electric vehicle safety control shaft having a specific assembly for reinforcing movement flexibility and an anti-collision device is capable of flexible movements. The assembly includes a handle formed with a shape as required; and a supporting housing joined below the handle, having a side thereof extended downward to form a connecting plate for fastening with a vehicle body, and a front end thereof disposed with a locating seat for joining with a connecting plate. The connecting plate also has an immobile gear for driving another slightly deviated immobile gear at the other end thereof using an interlocking belt to perform back-and-forth movements, provided with a locating spring and a locating block, thereby forming a complete structure with high stability. The invention is capable of bouncing back an original position thereof after springing in a backward direction without causing damages as colliding with hard objects.

### BACKGROUND OF THE INVENTION

(a) Field of the Invention

The invention relates to an electric vehicle safety control shaft capable of flexible movements, wherein the safety control shaft has a specific assembly for reinforcing movement flexibility of a control shaft of an electric vehicle, and an anti-collision device. The assembly according to the invention comprises a handle formed with a shape as required; and a supporting housing joined below the handle, having a side thereof extended downward to form a connecting plate for fastening with a vehicle body, and a front end thereof disposed with a locating seat for joining with a connecting plate. The connecting plate also has an immobile gear for driving another slightly deviated immobile gear at the other end thereof using a transmission belt to perform back-and-forth movements, thereby forming a complete structure according to the invention in conjunction with a locating spring and a locating block.
(b) Description of the Prior Art

Most current electric vehicle control shafts are attached in a fixed manner to a front section of an armrest of a chair. However, having a shortcoming of lacking adjustment capability for relative positions of the electric vehicle control shafts, such configuration fails to satisfy different needs of users.

Referring to the Patent Publication No. 444685 disclosing “Electric Vehicle Armrest Capable of Moving Control Shaft”, the prior invention is capable of effectively adjusting relative positions of the control shaft. Using this method, relative positions of the electric vehicle control shaft are adjusted to adapt to different needs of users.

Yet, this prior invention still has the following structural issues:
1. Adjustment of relative positions according to this prior invention cannot provide the control shaft with effective and rhythmic movements to move to appropriate positions, and thus adding uncertainties.
2. The structure for movements is devised with a connecting shaft, which potentially leads to another shortcoming of having inadequate stability during movements.
3. The structure according to the prior invention is rather rigid, and hence has limited resistance against impairment when being collided such that damages of a vehicle body or even a user are likely incurred.

Supposed the prior invention is implemented as safety and escape equipment in conventional buildings, the aforesaid shortcomings become even more apparent regarding practicability of the prior invention. Therefore, it is a vital task of the invention as how to provide a novel electric vehicle safety control shaft that is able to protect building lifespan as well as user safety.

### SUMMARY OF THE INVENTION

The primary object of the invention is to provide an electric vehicle safety control shaft capable of flexible movements. Using back-and-forth movements of a slightly deviated immobile gear driven by a transmission belt, and in conjunction of a locating spring and a locating block, the invention is provided with effective and rhythmic movements as well as high stability. In addition, when collided with an alien object, the invention is bounced to an original position thereof after springing in a backward direction without causing damages as colliding with hard objects, thereby enhancing safety and efficiency of the invention.

### BRIEF DESCRIPTION OF THE DRAWINGS

FIG. 1 shows an elevational schematic view according to the invention in assembly.

FIG. 2 shows an elevational schematic view according to the invention in disassembly.

FIG. 3 shows an exploded elevational schematic view according to the invention.

FIG. 4 shows a top schematic view illustrating motions after collision according to the invention.

FIG. 5 shows a top schematic view illustrating motions before collision according to the invention.

FIG. 6 shows an elevational schematic view of a preferred embodiment according to the invention.

### DETAILED DESCRIPTION OF THE PREFERRED EMBODIMENTS

To better understand structures, operation methods, spirit and objects of the invention, detailed descriptions shall be given with the accompanying drawings below.

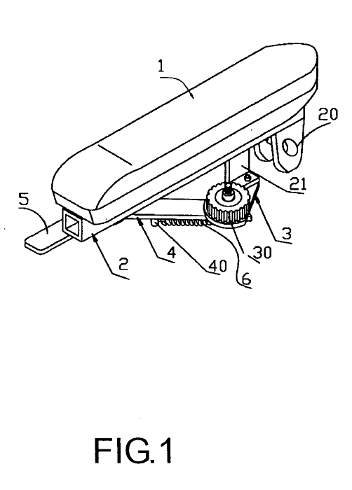

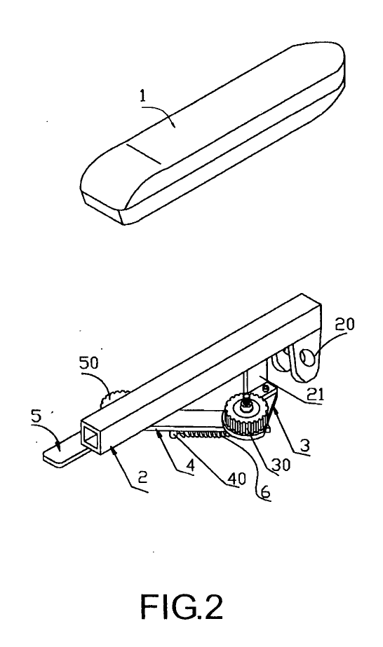

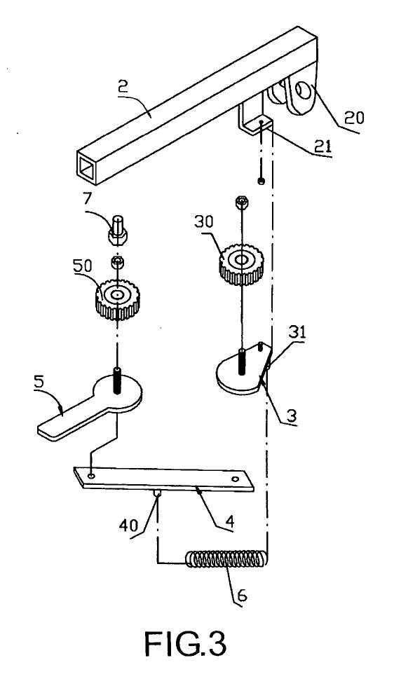

Referring to FIGS. 1, 2, and 3, an electric vehicle safety control shaft capable of flexible movements, comprises a handle 1 having a shape formed as required, a supporting housing 2 below the handle 1, a connecting plate 3 joined below the supporting housing 2 and having an immobile gear 30, a transmission plate 4 having an interlocking belt 8, a control shaft seat 5 having an immobile gear 50, a locating spring 6, and a locating block 7.

The handle 1 located at a side of the vehicle is for resting an arm, and is joined with the supporting housing 2 and the control shaft seat 5.

The supporting housing 2 is a framework joined with the handle 1 above; and has one end thereof extended downward to form an attaching board 20 for fastening with the supporting housing 2, the control shaft structure and the handle 1 with a body of the vehicle, and an end thereof approaching the connecting plate 3 provided with a locating seat 21 joined with the connecting plate 3.

The connecting plate 3 has a rear end thereof joined below the locating seat 21, an upper front end thereof placed with a connecting plate immobile gear 30, and a lower side thereof disposed with a connecting plate protruding section 31 for engaging within the locating spring 6.

The transmission plate 4 is penetrated with a slight deviation below the supporting housing 2 to appear as X-shaped when viewed from the top; and has one end thereof joined with a lower front end of the connecting plate 3, the other upper end thereof disposed with the handling shaft seat 5, and a lower section thereof similarly provided with a transmission plate protruding section 40 for engaging within the other end of the locating spring 6.

The control shaft seat 5 has a lower rear section thereof joined with the transmission plate 4, an upper rear end thereof disposed with a control shaft seat immobile gear 50, and a front end thereof for accommodating the control shaft.

The locating spring 6 has one end thereof engaged within the connecting plate protruding section 31, and the other end thereof engaged within the transmission plate protruding section 40. Using particular loop elasticity effects of the locating spring 6, the control shaft seat 5 is allowed with effective rhythmic movements for high stability. In addition, without causing damages as when colliding with hard objects, the control shaft 5 is capable of bouncing back to an original deviated position after being collided and springing backward.

The locating block 7 is fastened to the control shaft seat immobile gear 50 using screw means, and is leaned against the supporting housing 2 to serve for locating purposes, thereby accomplishing functional completeness of the invention.

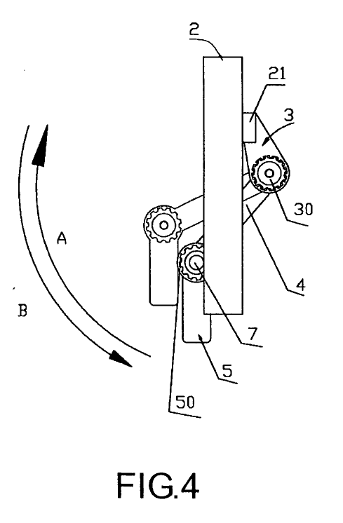

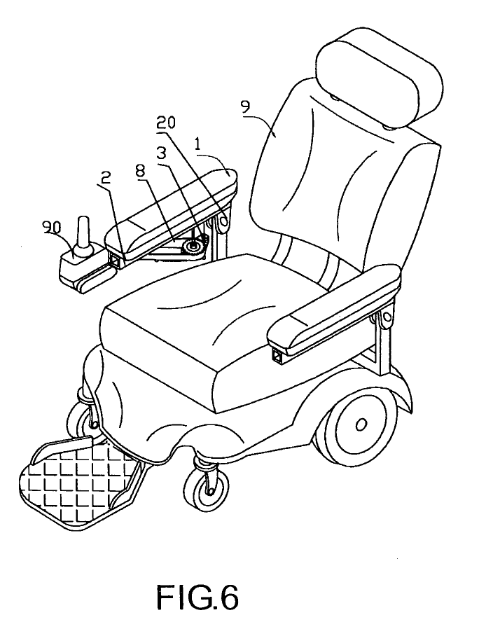

Referring to FIGS. 4, 5 and 6, to assemble the electric vehicle safety control shaft capable of flexible movements according to the invention, a lower section of the handle 1 is joined with an upper section of the supporting housing 2. The attaching board 20 at the lower section of the supporting housing 2 is fastened with a vehicle body 9, and the supporting housing 2 is joined with the connecting plate 3 using the locating seat 21 thereof. A rear end of the connecting plate 3 is joined with the lower section of the locating seat 21. The connecting plate 3 has a has the rear end thereof joined below the locating seat 21, the upper front end thereof placed with a connecting plate immobile gear 30, and the lower front end thereof joined with the transmission plate 4. The transmission plate 4 is penetrated with a slight deviation below the supporting housing 2 to appear as X-shaped when view from the top, and has one upper end thereof connected with the handling shaft seat 5. The locating spring 6 has one end thereof engaged within the connecting plate protruding section 31 and the other end thereof engaged within the transmission plate protruding section 40. The control shaft seat 5 has the lower rear section thereof joined with the transmission plate 4, an upper rear end thereof disposed with the control shaft seat immobile gear 50 fastened with the locating block 7 using screw means, wherein the locating block 7 is leaned against a side of the supporting housing 2 to serve for locating purposes. The control shaft seat 5 has the front end thereof for placing the control shaft 90. Referring to FIG. 6 showing an implementation according to the invention, an interlocking belt 8 is joined between the connecting plate immobile gear 30 and the control shaft seat immobile gear 50.

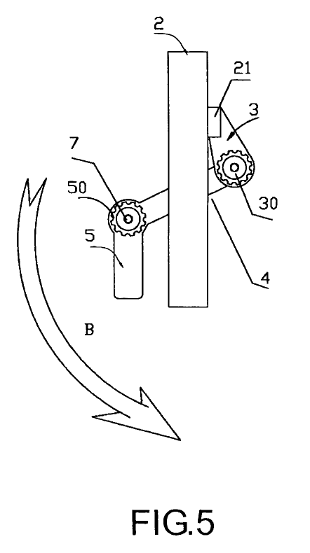

To apply the electric vehicle safety control shaft capable of flexible movements to an electric vehicle, with slight deviation, the transmission plate 4 is penetrated below the supporting housing 2 and is leaned against the supporting housing 2 using the locating block 7 to appear as X-shaped when viewed from the top. For that the control shaft is devised as being slight deviated, a user is favored in controlling the vehicle body 9. Using particular loop elasticity effects of the locating spring 6 and in conjunction with the interlocking belt 8, the control shaft seat 5 is allowed with effective rhythmic movements and high stability to move to an appropriate position. In addition, referring to FIG. 4, when collided with an alien object, the control shaft is sprung backward with deviation along a direction A. When an external force is dismissed as shown in FIG. 5, the control shaft 5 is bounced back to an original deviated position thereof along a direction B without causing damages of the vehicle body or the user as when colliding with hard objects, thereby completely accomplishing functions and effects of operations of the electric vehicle safety control shaft capable of flexible movements.

Conclusive from the aforesaid descriptions, the invention has simple structures and is capable of eliminating shortcomings of prior inventions. It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. An electric vehicle safety control shaft capable of flexible movements, comprising a handle formed with a shape formed as required, a supporting housing below the handle, a connecting plate joined below the supporting housing and having an immobile gear, a transmission plate having an interlocking belt, a control shaft seat having an immobile gear, a locating spring, and a locating block; wherein:
the supporting housing is a framework joined with the handle above;
and has one end thereof extended downward to form an attaching board for fastening the supporting housing, the control shaft structure and the handle with the vehicle body, and an end thereof approaching the connecting plate provided with a locating seat joined with the connecting plate;
the connecting plate has a rear end thereof joined below the locating seat, an upper front end thereof placed with a connecting plate immobile gear, and a lower side thereof disposed with a connecting plate protruding section for engaging within a locating spring;
the transmission plate is penetrated with a slight deviation below the supporting housing to appear as X-shaped when view from the top;
and has one end thereof joined with a lower front end of the connecting plate, the other upper end thereof connected with the handling shaft seat, and a lower section thereof similarly provided with a transmission plate protruding section for engaging within the other end of the locating spring;
the control shaft seat has a lower rear section thereof joined with the transmission plate, an upper rear end thereof disposed with a control shaft seat immobile gear, and a front end thereof for accommodating the control shaft;
the locating spring has one end thereof engaged within the connecting plate protruding section, and the other end thereof engaged within the transmission plate protruding section; and
the locating block is fastened to the control shaft seat immobile gear using screw means, and is leaned against the supporting housing.

2. The electric vehicle safety control shaft in accordance with claim 1, wherein the connecting plate immobile gear and the control shaft seat immobile gear is joined with an interlocking belt in between for coordinating with the locating spring.
